(19) United States
(12) Patent Application Publication
(10) Pub. No.: US 2024/0313298 A1
(43) Pub. Date: Sep. 19, 2024

(54) ENERGY STORAGE DEVICE HAVING CELL WITH SLEEVE

(71) Applicant: DEERE & COMPANY, MOLINE, IL (US)

(72) Inventor: Thomas L. KENNEDY, Bettendorf, IA (US)

(21) Appl. No.: 18/470,596

(22) Filed: Sep. 20, 2023

Related U.S. Application Data
(60) Provisional application No. 63/490,045, filed on Mar. 14, 2023.

(51) Int. Cl. H01M 10/657; H01M 10/643; H01M 10/653; H01M 10/6567; H01M 50/107; H01M 50/119; H01M 50/202; H01M 50/213; H01M 50/224; H01M 50/227; H01M 50/231; H01M 50/233

(52) U.S. Cl. CPC H01M 10/657; H01M 10/643; H01M 10/653; H01M 10/6567; H01M 50/107; H01M 50/119; H01M 50/202; H01M 50/213; H01M 50/224; H01M 50/227; H01M 50/231; H01M 50/233

(57) ABSTRACT

An energy storage device includes at least one energy storage cell and at least one sleeve disposed around the at least one energy storage cell. The energy storage cell includes a metal case having an outer dimension and the sleeve includes a chamber having an inner dimension larger than the outer dimension of the case, wherein the chamber is configured to receive the energy storage cell. A plurality of energy storage devices are located in an energy storage module, wherein each one of the plurality of energy storage devices is located in one of a plurality of compartments located in a block of the energy storage module. An electrically conductive fluid is directed to the plurality of energy devices through a passageway of the block.

### CROSS-REFERENCE TO RELATED APPLICATION

This application claims priority to U.S. Provisional Application No. 63/490,045, filed Mar. 14, 2023, entitled “Energy Storage Device Having Cell with Sleeve” the disclosure of which is hereby incorporated by reference in its entirety.

### FIELD OF THE DISCLOSURE

The present disclosure relates to an energy storage device and more particularly to an energy storage device including immersion cooled batteries.

### BACKGROUND

Energy storage devices, such as electric batteries in electric vehicles, may utilize active heating and active cooling based on desired charge and discharge currents for vehicle requirements.

### SUMMARY

According to an aspect of the present disclosure, an energy storage device includes at least one energy storage cell and at least one sleeve disposed around the at least one energy storage cell.

In one embodiment, there is provided an energy storage device including an energy storage cell and a sleeve disposed around the energy storage cell.

In some embodiments, the energy storage device includes wherein the energy storage cell includes a metal case having an outer dimension and the sleeve includes a chamber having an inner dimension larger than the outer dimension of the case, wherein the chamber is configured to receive the energy storage cell.

In some embodiments, the energy storage device includes wherein the sleeve comprises a metal sleeve.

In some embodiments, the energy storage device includes wherein the chamber of the metal sleeve includes an interior wall having a surface, and the interior wall is coated with an electrically insulating coating.

In some embodiments, the energy storage device includes wherein the electrically insulating coating is an electrically insulating lacquer.

In some embodiments, the energy storage device further includes a dielectric lubricant disposed between the electrically insulating lacquer and the metal case.

In some embodiments, the energy storage device includes wherein the metal case is configured as a first cylinder and the chamber of the metal sleeve is configured as a second cylinder, wherein the dielectric lubricant provides a dielectric insulator between the first cylinder and the second cylinder.

In some embodiments, the energy storage device includes wherein the dielectric lubricant provides sliding movement of the energy storage cell into the chamber of the metal sleeve.

In another embodiment, there is provided an energy storage module including a plurality of battery cells, wherein each of the battery cells includes a metal case and a plurality of sleeves including an interior surface, wherein the interior surface comprises a non-conductive but thermally conductive layer. A block includes a plurality of compartments, wherein each one of the plurality of compartments is lined with a one of the plurality of sleeves, wherein one battery cell of each of the plurality of battery cells is disposed in one of the plurality of sleeves.

In some embodiments, the energy storage module includes wherein each one of the plurality of the battery cells includes a metal case having an outer dimension and each one of the plurality of sleeves includes a chamber having an inner dimension larger than the outer dimension of the case, wherein the chamber is configured to receive the one of the plurality of batter cells and one of the plurality of sleeves.

In some embodiments, the energy storage module includes wherein each one of the plurality of sleeves comprises a metal sleeve.

In some embodiments, the energy storage module includes wherein the non-conductive but thermally conductive layer comprises a deposited electrically insulating coating.

In some embodiments, the energy storage module includes wherein the non-conductive but thermally conductive layer comprises an electrically insulating lacquer.

In some embodiments, the energy storage module further includes a dielectric lubricant disposed between the electrically insulating coating and the battery cell.

In some embodiments, the energy storage module includes wherein the dielectric lubricant provides sliding movement of the battery cell into the metal sleeve.

In some embodiments, the energy storage module includes wherein the block includes a molded block formed in a mold and each of the plurality of sleeves is molded into the molded block to define each of the plurality of compartments.

In some embodiments, the energy storage module includes wherein each of the plurality of sleeves includes a plastic sleeve.

In some embodiments, the energy storage module of claim includes wherein the block includes a molded block formed in a mold and each of the plurality of sleeves is coupled to the molded block at each of the plurality of compartments by a friction weld or a sonic weld.

In a further embodiment, these is provided a method of controlling a temperature of an electric vehicle battery including a battery module having a plurality of compartments and a fluid passage, wherein each of the plurality of compartments is coupled to the fluid passage. The method includes: applying an electrically insulating material to an interior of each of a plurality of sleeves; placing one of the plurality of sleeves in each one of the plurality of compartments, wherein the one of the plurality of sleeves is located adjacent the passage; inserting a battery cell from a plurality of battery cells in each one of the plurality of sleeves; delivering an electrically conductive fluid through the fluid passage of each of the plurality sleeves of compartments; and controlling a temperature of the electrically conductive fluid to control the temperature of the plurality of battery cells

In some embodiments, the method includes wherein inserting the battery cell includes inserting the battery cell into the compartment with a dielectric lubricant to prevent damage to the battery cell during insertion and to provide a path for heat exchange between the battery cell and the electrically conductive fluid.

Other features and aspects will become apparent by consideration of the detailed description, claims, and accompanying drawings.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings.

FIG. 1 illustrates an energy storage device in accordance with an embodiment of the present disclosure

FIG. 2 illustrates an energy storage module including a plurality of energy storage devices having temperature control provided by an electrically conductive cooling fluid.

FIG. 3 illustrates an energy storage module including a plurality of energy storage devices, a few of which is illustrated in a sectional view.

FIG. 4 illustrates a sectional view of a compartment of an energy storage module.

FIG. 5 illustrates a cross-sectional view of a sleeve located within a compartment of an energy storage module.

FIG. 6 illustrates a sleeve of an energy storage device formed as part of a base of an energy storage module.

FIG. 7 illustrates a sleeve held in place at a compartment of an energy storage module by one or more welds.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

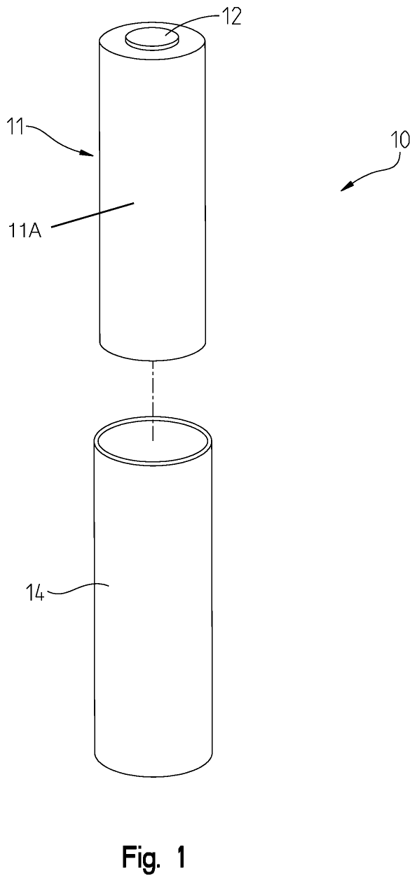

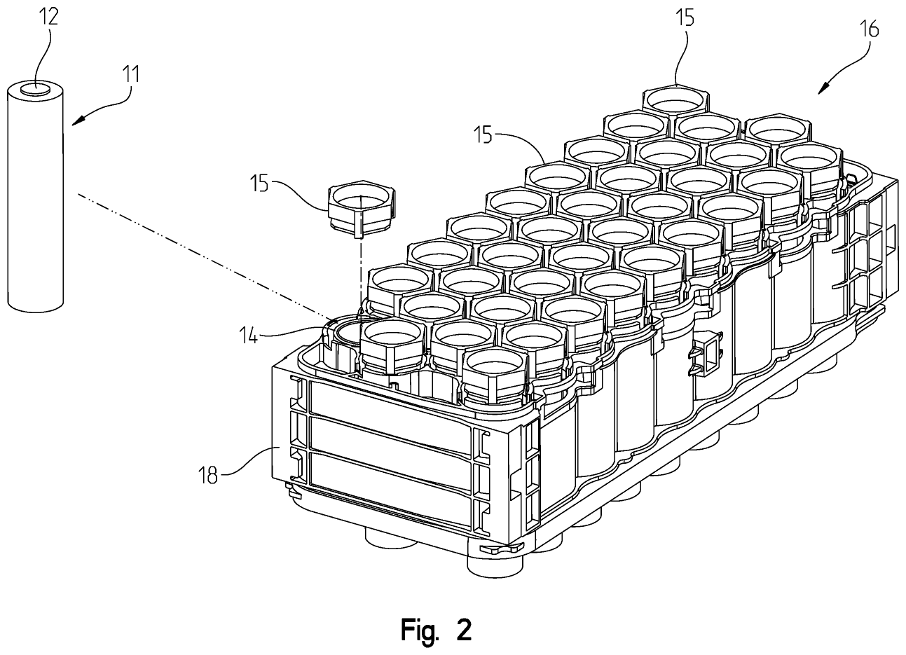

FIG. 1 illustrates an energy storage device 10 that includes a battery cell 11 including a positive electrode 12 a negative electrode provided by an outer surface 11A of the battery cell 11, and a sleeve 14. The energy storage cell 10 is used, for instance, in an energy storage device, such as in electric battery modules, for electric vehicles. An energy storage module 16 of FIG. 2 may utilize active heating and active cooling based on desired charge and discharge currents for vehicle needs. Heating, cooling, and/or any other thermal management may include passive air cooling by flowing air around cells 11 and through a base 18 that supports a plurality of energy storage cells. Active indirect cooling is achieved by placing the cells 11 in close proximity to a heat exchanger, such as a water-glycol cooled heat exchanger, and/or immersion cooling the cells 11 by placing them in direct contact with a cooling fluid. The battery cell 11 may be held in place within this sleeve 14 through a number of different means (adhesive caps, screw in caps, etc.).

Immersion cooling of only the battery cells 11 may be effective due to direct thermal exchange, i.e. contact of a cooling fluid with a surface of the cell 11. In such a configuration, however, a non-conductive dielectric fluid has been used as the cooling fluid while electrically insulating cells 11 in the energy storage device. Dielectric fluids are typically made of oil, and this may lead to both high pumping inefficiency due to poor viscosity in low temperatures and lower heat transfer due to the thermal conductivities of oil. Additionally, the pressures of the fluid around the cells 11 and/or within the energy storage module 16 may need to remain within a low range due to the structural integrity of the cell 11.

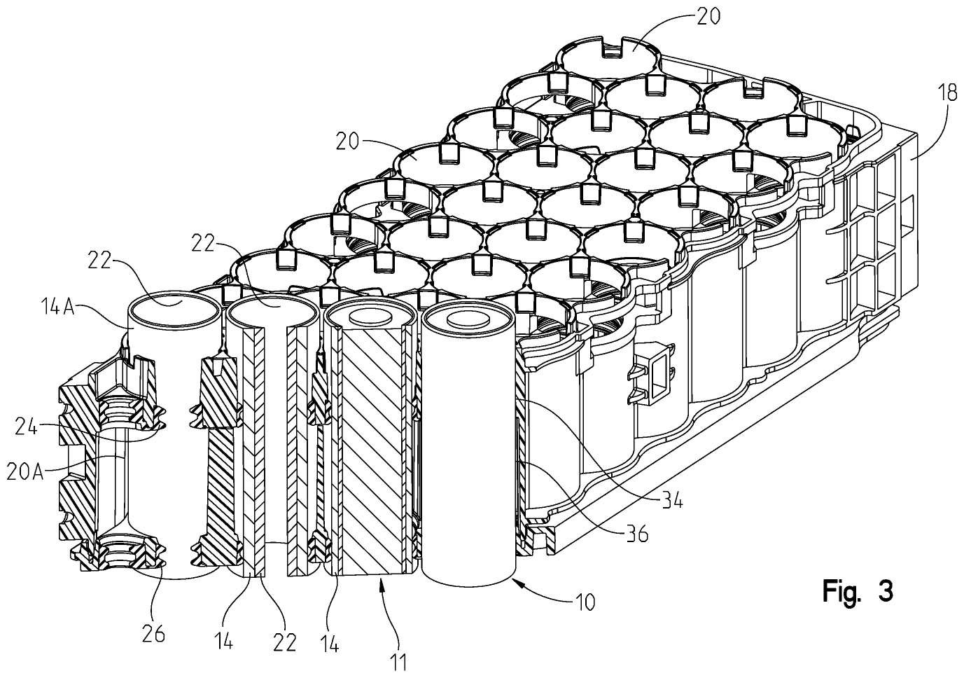

The energy storage module 16, illustrated in FIG. 2, enables the use of a water-ethylene glycol or other electrically conductive cooling fluid. The energy storage module 16, of one embodiment, includes the base 18 which supports a plurality of the sleeves 14, wherein each cell 11 is located within a chamber defined by one of the sleeves 14. In some embodiments, the sleeves 14 includes a metal jacket configured to surround different types of cells 11 that are either cylindrical or not cylindrical. As seen in FIG. 3, each of the sleeves 14 covers a respective one of the cells 11. A cap 15 is place over the electrode 12 of each of the cells 11 and provides electrical connection of the cells for providing electrical power from the module 12 to an electric vehicle.

The sleeve 14 of the energy storage device 10 includes a cylindrical metal sleeve that is held within and lines a compartment 20 defined in the base 18 of the energy storage module 16. See sleeve 14 of FIG. 2 and sleeves 14 of FIG. 3. The sleeve 14, of one embodiment, may be coated with an electrically insulating lacquer or other coating 22, which is disposed on an interior surface of the sleeve 14. In different embodiments, the coating is applied to the interior surface by a number of methods including depositing, spraying, painting, or electrostatic application. The electrically insulating coating 22 is used to separate a metal case of the cell 11 from the metal sleeve 14, the exterior surface of which is in contact with the electrically conductive cooling fluid flowing through the energy storage module 16.

The metal sleeve 14 may be sized such that an inner diameter of the sleeve 14 is approximately slightly larger than an outer diameter of the battery cell 11 itself to enable insertion of the battery cell into the sleeve. In one embodiment, the cell 11 may then be inserted into the sleeve 14 by applying a dielectric lubricant or grease between the inner surface of the sleeve 14 and the outer surface of the cell 11. The dielectric lubricant may prevent damage to the battery cell 11 during assembly and which provides a path for heat exchange between the sleeve 14 and cell 11 through the cooling fluid. In additional embodiments, the inner diameter of the sleeve 14 is larger than the outer diameter of the battery cell 11, and a dielectric fluid and/or grease layer provides electrical insulation instead of, or in addition to, the electrically insulating lacquer or other coating. In additional embodiments, the sleeve 14 is installed with the cell 11 without the dielectric lubricant or grease. In this embodiment, the interior surface of the sleeve 14 is slightly larger than the outer surface of the cell 11 to enable insertion of the cell while providing sufficient contact for heating or cooling of the cell 11.

As seen in FIG. 3, a plurality of compartments 20 is illustrated in cross-section to illustrate the configuration of the battery cells 11 and the sleeves 14. For instance, sleeve 14A is located within a compartment 20A which includes a first gasket 24 and a second gasket 26. Each of the first gasket 24 and the second gasket 26 are held in place by a feature of the base 18. Once the gaskets are in place, the sleeve 14A is inserted into the compartment 20A by sliding the sleeve 14 into and past each of the first and second gaskets 24 and 26.

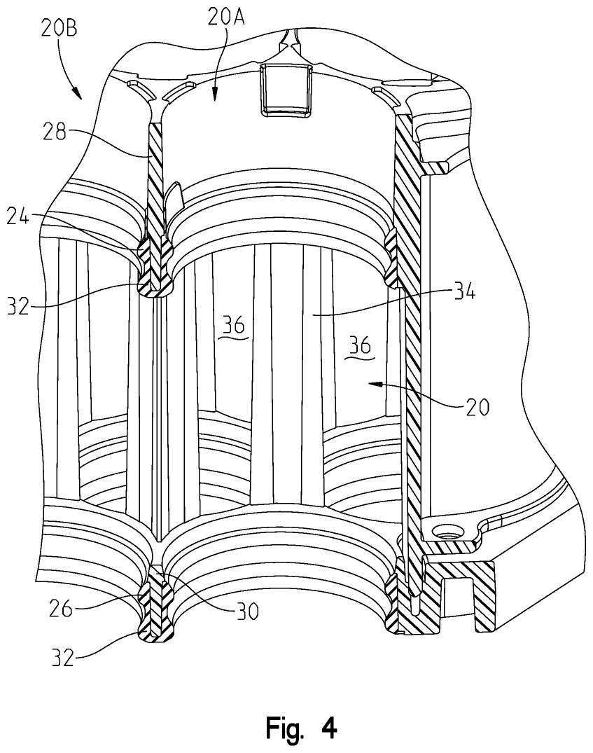

FIG. 4 illustrates a sectional view of one embodiment of the compartment 20A and an adjacent compartment 20B. Compartment 20A and compartment 20B includes a cylindrical sidewall 28 and a cylindrical sidewall 30. Each of the gaskets 24 and 26 defines cylindrical slots 32 that respectively receive the sidewall 28 and the sidewall 30. The sidewalls 28 and 30 are spaced apart by one or more pillars 34. The pillars 34 define an opening 36 therebetween which is coupled through a fluid passage to a fluid source, not shown. The fluid passage directs the electrically conductive fluid from the fluid source to an exterior surface of the sleeves 14. The fluid is temperature controlled and either cools or heats the sleeves 14, which in turn cools or heats the battery cells 11.

Each of the openings 36 is fluidly coupled to an inlet (not shown) of the base 18 which receives the electrically conductive fluid to insure a proper operating temperature of the energy storage module 16. The base 18 includes an outlet, not shown, which transfer the fluid, which has been heated by operation of the cells, from energy transfer from the energy storage module 16. The fluid is cooled, if heated, and is returned to the inlet to provide a cooling effect to the energy storage cells.

Returning to FIG. 3, the sleeve 14A is shown in a cross-sectional view to illustrate the electrically insulating lacquer or other coating layer 22, which is disposed on an interior surface of the sleeve 14A. The coating layer 22 is applied to the interior surface of the sleeve to coat the entire surface for insulating the conducting metal surface of the sleeve from the metal case of the battery cell 11. In one embodiment, to facilitate positioning of the battery cell 11 within the coated sleeve 14, the interior coated surfaces of each of the sleeves 14, in are coated with a dielectric lubricant or grease. The dielectric lubricant or grease may act as an electrical insulation instead of or in addition to the electrically insulating lacquer or other coating layer 22.

In FIG. 3, the energy storage cell 11 is also shown in a cross-sectional view with the sleeve 14A also shown in cross section. The coating layer 22A of the sleeve 14 is disposed directly adjacent to an exterior surface of the energy storage cell. If the coating layer 22A or the exterior surface of the energy storage cell 11A has been coated with a fluid, heat transfer or cooling transfer between the coating layer 22A and the exterior surface of the cell is facilitated. In other embodiments, neither the exterior surface of the energy storage cell 11A nor the interior coated layer 22A of the sleeve is coated with the addition of a fluid, but contact between the coated layer 22A and the surface of the energy storage cell 11A is sufficient to cool the cell 11 A.

FIG. 3 also shows an energy storage cell 10A in a non-sectional view to illustrate the complete storage cell 10. As seen in FIG. 3, an opening 36 is shown between one of the pillars 34 of the base 18 and the sleeve 14. The opening 36 delivers the conductive fluid to the sleeve 14.

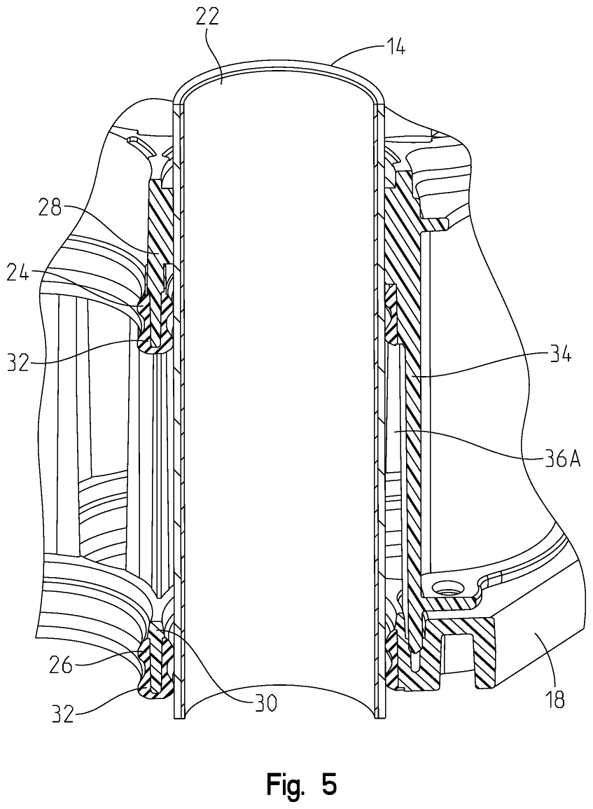

FIG. 5 illustrates a cross-sectional view of the sleeve 14 located within the compartment 20. The sleeve 14 includes the coating layer 22, which in one embodiment, is thinner than a thickness of the sleeve 14. The range of thickness of the coating layer 22 and the coating material selected is dependent on the voltage level of the battery cells. ISO/DIS 23285 describes different voltage classes each of which may require a different thickness of the coating layer 22.

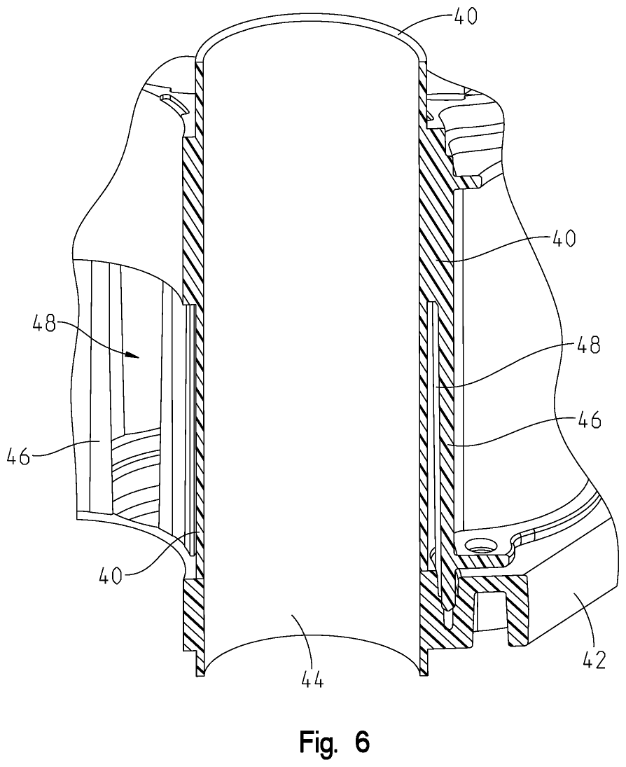

FIG. 6 illustrates another embodiment of a sleeve 40 which is formed as part of a base 42. In this embodiment, the base 42 includes a plurality of sleeves 40, each of which is formed as a part of the base 42. In this embodiment, the sleeves 40 are not readily separable from the base 42 but are fixed as a part of the base 42. In one or more embodiments, the sleeves 40 are formed of the same material as the base. In one embodiment, the material is a plastic. In this embodiment, the sleeve 40 includes an interior surface 44 which does not include an inner coating layer located on the interior surface 44. The base 42 includes pillars 46 that extend along a portion of the sleeve 40 to define openings 48 to deliver the cooling fluid to the sides of the sleeve 40. In one embodiment, the sleeve 40 is coated with an oil to assist in sliding movement of a cell 11 into the sleeve 40. In different embodiments, the type of plastic material and the thickness of the type of plastic material is based on the voltage level of the battery cells.

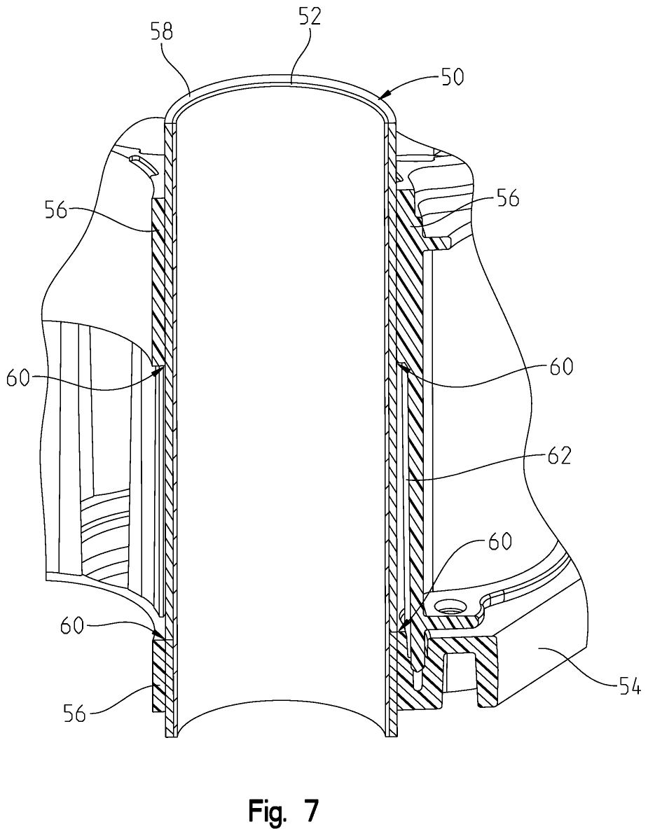

FIG. 7 illustrates a further embodiment of a sleeve 50, and having in interior surface thereof coated with a coating 52 as described herein. In this embodiment, the sleeve 50, once formed and coated, is placed in a base 54. The base 54 includes interior sidewalls 56 that extend along a portion of an exterior surface 58 of the sleeve 50. In this embodiment, the sleeve 58 is held in place by one or more welds 60, such as a sonic or an ultrasonic weld that is located at an interface between the exterior surface 58 and an exposed edge of the base 54. These locations are placed to insure a fluid-tight seal between the sidewalls 56 and the exterior surface 58 of the sleeve 50. Openings 62 receive the cooling fluid as described herein, but the welds 60 prevent fluid from moving between the sleeve 50 and the interior sidewalls of the bae 54. In different embodiments, the sleeve 50 includes a plastic sleeve or a metal sleeve.

Without in any way limiting the scope, interpretation, or application of the claims appearing below, a technical effect of one or more of the example embodiments disclosed herein is an increase in the number of pumping solutions and potential suppliers available for the energy storage device 10 and its various components as water-ethylene glycol coolant pumps are more plentiful in industry than low pressure, high-volume oil pumps.

Another technical effect of one or more of the example embodiments disclosed herein is the elimination of an additional fluid and corresponding components from the vehicle, including one or more tanks, pressure relief valves, breathers, pumps, heat exchangers, and sensors to monitor dielectric properties of the fluid, which results in a significant cost savings for the energy storage device 10 and vehicle.

Another technical effect of one or more example embodiments disclosed herein is the improvement of heat transfer into and out of the battery cells 11. Another technical effect of one or more example embodiments disclosed herein is the improvement of the durability and life of the cells 11 and the energy storage device 10 by lowering cell to cell temperature variation. Other technical effects of one or more embodiments disclosed herein include the ability to increase the pressure of the coolant circuit and the ability to decrease required pumping power for circulating the cooling fluid.

Any disclosure of a cell described in any embodiments herein includes a cylindrical cell, a prismatic cell, a pouch cell, and/or any other cell or energy storage form. In a non-limiting example, the sleeve 14 may be a rectangular structure to accommodate a prismatic or pouch cell.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. An energy storage device comprising:
an energy storage cell; and
a sleeve disposed around the energy storage cell.

2. The energy storage device of claim 1, wherein the energy storage cell includes a metal case having an outer dimension and the sleeve includes a chamber having an inner dimension larger than the outer dimension of the case, wherein the chamber is configured to receive the energy storage cell.

3. The energy storage device of claim 2 wherein the sleeve comprises a metal sleeve.

4. The energy storage device of claim 3 wherein the chamber of the metal sleeve includes an interior wall having a surface, and the interior wall is coated with an electrically insulating coating.

5. The energy storage device of claim 4 wherein the electrically insulating coating is an electrically insulating lacquer.

6. The energy storage device of claim 4 further comprising a dielectric lubricant disposed between the electrically insulating lacquer and the metal case.

7. The energy storage device of claim 6 wherein the metal case is configured as a first cylinder and the chamber of the metal sleeve is configured as a second cylinder, wherein the dielectric lubricant provides a dielectric insulator between the first cylinder and the second cylinder.

8. The energy storage device of claim 7 wherein the dielectric lubricant provides sliding movement of the energy storage cell into the chamber of the metal sleeve.

9. An energy storage module comprising:
a plurality of battery cells, wherein each of the battery cells includes a metal case;
a plurality of sleeves including an interior surface, wherein the interior surface comprises a non-conductive but thermally conductive layer;
a block including a plurality of compartments, wherein each one of the plurality of compartments is lined with a one of the plurality of sleeves;
wherein one battery cell of each of the plurality of battery cells is disposed in one of the plurality of sleeves.

10. The energy storage module of claim 9, wherein each one of the plurality of the battery cells includes a metal case having an outer dimension and each one of the plurality of sleeves includes a chamber having an inner dimension larger than the outer dimension of the case, wherein the chamber is configured to receive the one of the plurality of batter cells and one of the plurality of sleeves.

11. The energy storage module of claim 10 wherein each one of the plurality of sleeves comprises a metal sleeve.

12. The energy storage module of claim 11 wherein the non-conductive but thermally conductive layer comprises a deposited electrically insulating coating.

13. The energy storage module of claim 11 wherein the non-conductive but thermally conductive layer comprises an electrically insulating lacquer.

14. The energy storage module of claim 12 further comprising a dielectric lubricant disposed between the electrically insulating coating and the battery cell.

15. The energy storage module of claim 14 wherein the dielectric lubricant provides sliding movement of the battery cell into the metal sleeve.

16. The energy storage module of claim 10 wherein the block includes a molded block formed in a mold and each of the plurality of sleeves is molded into the molded block to define each of the plurality of compartments.

17. The energy storage module of claim 10 wherein each of the plurality of sleeves comprises a plastic sleeve.

18. The energy storage module of claim 10 wherein the block includes a molded block formed in a mold and each of the plurality of sleeves is coupled to the molded block at each of the plurality of compartments by a friction weld or a sonic weld.

19. A method of controlling a temperature of an electric vehicle battery including a battery module having a plurality of compartments and a fluid passage, wherein each of the plurality of compartments is coupled to the fluid passage, the method comprising:
applying an electrically insulating material to an interior of each of a plurality of sleeves;
placing one of a plurality of sleeves in each one of the plurality of compartments, wherein each one of the plurality of sleeves is located adjacent the fluid passage;
inserting a battery cell from a plurality of a battery cells in each one of the plurality of sleeves;
delivering an electrically conductive fluid through the fluid passage of each of the plurality sleeves; and
controlling a temperature of the electrically conductive fluid to control the temperature of the plurality of battery cells.

20. The method of claim 19 wherein inserting the battery cell includes inserting the battery cell into the compartment with a dielectric lubricant to prevent damage to the battery cell during insertion and to provide a path for heat exchange between the battery cell and the electrically conductive fluid.
